(19) United States
(12) Patent Application Publication
(10) Pub. No.: US 2026/0147692 A1
(43) Pub. Date: May 28, 2026

(54) SOFTWARE APPLICATION TRAINING USING TEST CASES

(71) Applicant: SAP SE, Walldorf (DE)

(72) Inventors: Shanavas Madeen S, Krishnagir (IN); Naveen V, Hariharapura (IN)

(21) Appl. No.: 18/963,014

(22) Filed: Nov. 27, 2024

(51) Int. Cl. G06F 11/3668

(52) U.S. Cl. CPC G06F 11/3684; G06F 11/3688

(57) ABSTRACT

Various examples are directed to systems and methods for supporting an application. A training automation tool may receive process data describing an application process is to be performed by a user with the application. The training automation tool may execute a trained computerized model to generate an indication of an application test case for testing at least one feature of the application associated with the application process. The training automation tool may generate a set of application actions for performing the application process.

### BACKGROUND

Software applications can be built with advanced functionality. However, as the complexity of software application functionality increases, it becomes desirable to train users to correctly and easily utilize the software applications, including the relevant functionality.

### BRIEF DESCRIPTION OF DRAWINGS

The present disclosure is illustrated by way of example and not limitation in the following figures.

FIG. 1 is a diagram showing one example of an environment for software application training.

FIG. 2 is a flowchart showing one example of a process flow that may be executed in the environment of FIG. 1 to support the execution of the software application.

FIG. 3 is a diagram showing one example of a user interface screen that may be served to the user computing device of FIG. 1 by the application of FIG. 1 and a user interface screen that may be provided to the user computing device by the training automation tool of FIG. 1.

FIGS. 4-6 show additional examples of the user interface screen of FIG. 3.

FIG. 7 shows an example of a user interface screen that may be served to the user computing device by the application and the user interface screen 302 that may be provided to the user computing device by the training automation tool in response to the selection of the Continue button illustrated by FIG. 6.

FIG. 8 is a diagram showing an example portion of an application map.

FIG. 9 is a flowchart showing one example of a process flow that may be executed by the training automation tool of FIG. 1 to train the trained computerized model.

FIG. 10 is a flowchart showing another example of a process flow that may be executed in the environment of FIG. 1 to support the execution of the software application.

FIG. 11 is a diagram showing one example of a CI/CD pipeline incorporating various software testing described herein.

FIG. 12 is a block diagram showing one example of a software architecture for a computing device.

FIG. 13 is a block diagram of a machine in the example form of a computer system within which instructions may be executed for causing the machine to perform any one or more of the methodologies discussed herein.

### DETAILED DESCRIPTION

Enterprise resource planning (ERP) applications perform various application processes. For example, an ERP application supporting a human resources operation may perform application processes including, for example, storing/accessing employee records, generating payroll, managing benefits, and/or the like. An example ERP application supporting accounting may use records managed by the database management application to perform various application processes such as, for example, posting transactions, reconciling accounts, and/or the like. An ERP application supporting operations may be used to perform various different application processes such as, for example, generating purchase orders, generating shipping orders, generating invoices, and/or the like.

ERP applications and other applications may use specialized knowledge of the various applications in order to cause the software applications to perform the various application processes. The user inputs to cause an ERP application or other software application to perform an application process can, in some examples, be complex. Also, for example, the specific inputs to cause an ERP application or other software applications to perform a particular application process may depend on the data that the ERP application processes.

User training for ERP and other software applications can be handled by generating and providing training materials such as, for example, help topics, frequently asked questions, and/or the like. Also, in some examples, a software provider may provide a training mode or training version of an ERP or other software application. A user may execute the training version to practice performing various application processes.

In some examples, however, help topics, frequently asked questions, and training versions of software applications may still create challenges. For example, there may be multiple different ways and/or multiple different workflows for using an ERP or other software application to perform a particular processing task. Also, the user's experience with an ERP or other software application may vary depending on the underlying organizational data of the user's organization. Further, it may be desirable to regularly update training materials in conjunction with updates to the ERP or other software application.

Various examples described herein address these and other challenges using a training automation tool and one or more test cases. A test case is generated, for example, in conjunction with the development of a software application, to test the features of the software application. In some examples, a training automation tool may utilize test cases to determine a series of application actions to be performed by a user in order to accomplish a particular application process. For example, the automation tool may utilize a trained computerized model. The trained computerized model may be trained using test case data describing the test cases. The trained computerized model may generate an application map data structure. The application map data structure may describe clusters of related application actions, for example, associated with a common application process. The training automation tool may execute the trained computerized model to generate the application map. In some examples, the application map, including sequences of application actions, may be determined with respect to organizational data utilized by a particular organization.

When a user requests training assistance with respect to a particular application process, the automation tool may utilize the trained computerized model and/or the application map generated by the trained computerized model to a set of application actions for performing the application process. The set of application actions may include actions such as, for example, selecting a particular prompt, populating an input field generated by the software application, selecting a particular user interface element generated by the software application, and/or the like. In some examples, the set of application actions are arranged in a sequence where the sequence of the application actions is based on the sequence of application actions in one or more test cases and/or on the application map.

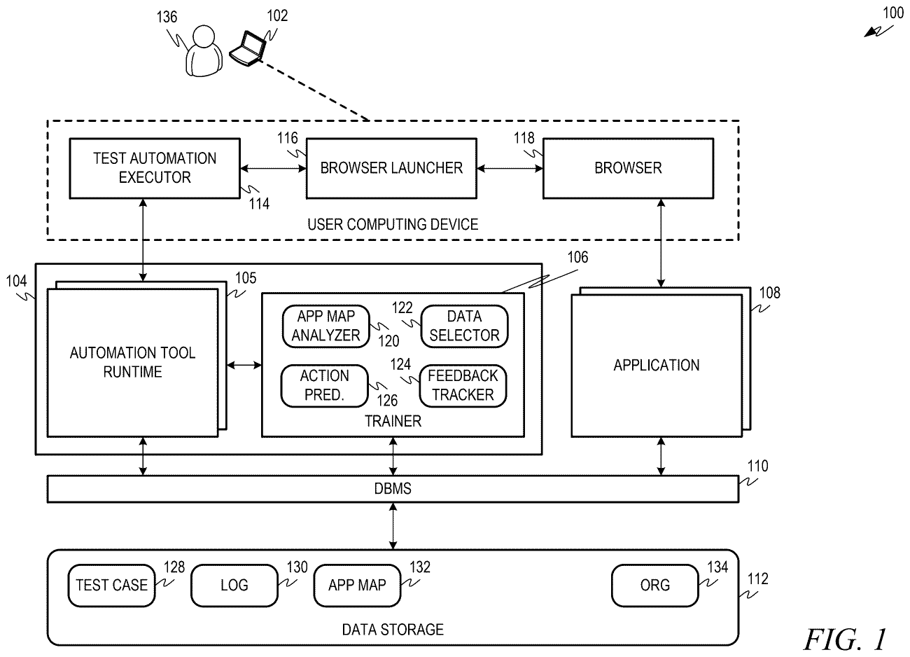

FIG. 1 is a diagram showing one example of an environment 100 for software application training. The environment 100 comprises a user computing device 102, a training automation tool 104, a software application 108, a database management system (DBMS) 110, and data storage 112. The user computing device 102 is used by a user 136. The user computing device 102 may be any suitable computing device such as, for example, a desktop computer, a laptop computer, a tablet computer, a mobile computing device, and/or the like. The user computing device 102 and/or user 136 may be associated with an enterprise. The enterprise may be a business concern or other organization implementing the software application 108. For example, user 136 may be an employee or other authorized user of the consumer enterprise.

The training automation tool 104, software application 108, and DBMS 110 may be executed at the user computing device 102 and/or remotely from the user computing device 102. For example, the training automation tool 104, software application 10A, and DBMS 110 may be implemented using low code/no code or any other suitable coding arrangement. In some examples, the training automation tool 104, software application 108, and DBMS 110 are executed at an on-premise computing system maintained by the consumer enterprise.

Also, in some examples, the training automation tool 104, software application 108, and DBMS 110 may be executed in a cloud environment, such as a public cloud environment or a private cloud environment. In a private cloud environment, the consumer enterprise may provide executables and other files to implement the training automation tool 104, software application 108, and/or DBMS 110 to a cloud service provider. The executables and other files may be obtained from a software provider enterprise

In a public cloud environment, users associated with the consumer enterprise, such as the user 136, are provided with access to the training automation tool 104, software application 108, and/or DBMS 110 through one of a number of tenancies. The software provider enterprise may provide executables and other files to implement the training automation tool 104, software application 108, and/or DBMS 110 and, in some examples, may also maintain the various tenancies. For example, users associated with different tenancies (such as tenancies held by different consumer enterprises) may access different installations of the training automation tool 104, software application 108, and/or DBMS 110 as well as different versions of data stored at the data storage 112.

The software application 108 may be any suitable application such as, for example, an ERP application. Example ERP applications include an analytics software solution such as the SAP® Analytics Cloud application available from SAP SE of Walldorf, Germany, a human capital management software solution such as SAP SuccessFactors®, also available from SAP SE of Walldorf, Germany, a project management software solution such as SAP Portfolio and Project Management (PaPM), also available from SAP SE of Walldorf, Germany. In some examples, multiple runtime instances of the software application 108 may execute. For example, each user using the application, either live or for training, may utilize a distinct instance of the software application.

The training automation tool 104 comprises one or more automation tool runtimes 105 and a trainer system 106. For example, the automation tool runtimes 105 and trainer system 106 may execute at the same computing system and/or independently, such as, at different computing systems. An automation tool runtime 105 may support execution of the software application 108 at the user computing device 102, for example, as described herein. The trainer system 106 may perform various functionality related to the training automation tool. For example, an application map analyzer 120 may execute a trained computerized model to generate and/or analyze a previously generated application map describing application processes and application actions for executing the application processes.

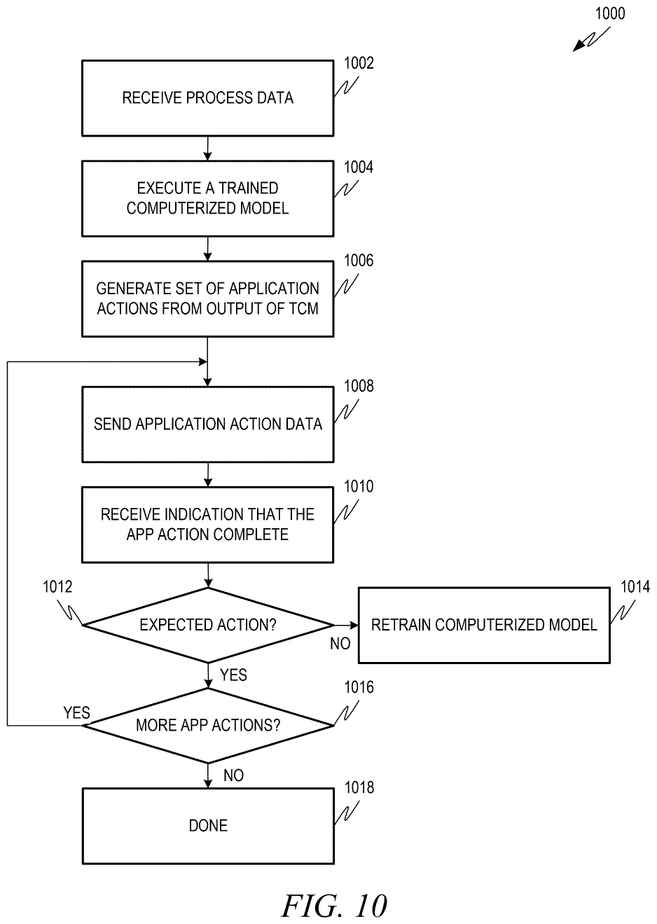

An action predictor 126 may utilize the application map generated by the application map analyzer 120 to select the next application action toward realizing an application process. A data selector 122 may select data to be provided to the user 136 with suggested application actions. A feedback tracker 124 may be programmed to monitor application actions actually executed by the user 136 and make modifications to the trained computerized model and/or application map in response thereto, for example, as described herein with respect to FIG. 10.

The training automation tool 104 and software application 108 may utilize data stored and managed by the DBMS 110. Example data that may be utilized includes test case data 128, log data 130, application map data 132, and organizational data 134.

Test case data 128 describes test cases. A test case may comprise input data describing a set of input parameters provided to a software application and result data describing how the software application is expected to behave when provided with the set of input parameters. The input parameters may include input data, a link to input data at an organizational database, commands, and/or the like. In some examples, the set of input parameters also includes a sequence of actions and/or a sequence of inputs to be provided to the software application.

In some examples, developers generate test cases to test the function of various features of the application. For example, test cases may be implemented in conjunction with a Continuous Integration/Continuous Delivery (CI/CD) or other suitable arrangement for testing or providing quality management for the software application 108.

Log data 130 describes previous executions of the training automation tool 104. For example, the log data may describe application actions suggested to a user, such as the user 136, to implement an application process. In some examples, log data 130 may also describe application actions actually implemented by the user 136 or other users. For example, if the user 136 chooses to perform the recommended application action, that may be recorded in the log data 130. Additionally, if the user chooses to perform a different application action, that too may be recorded in the log data 130. Log data 130 may serve as a proof of execution for the automation tool 104 and/or may provide information about the data used during a particular execution of the software.

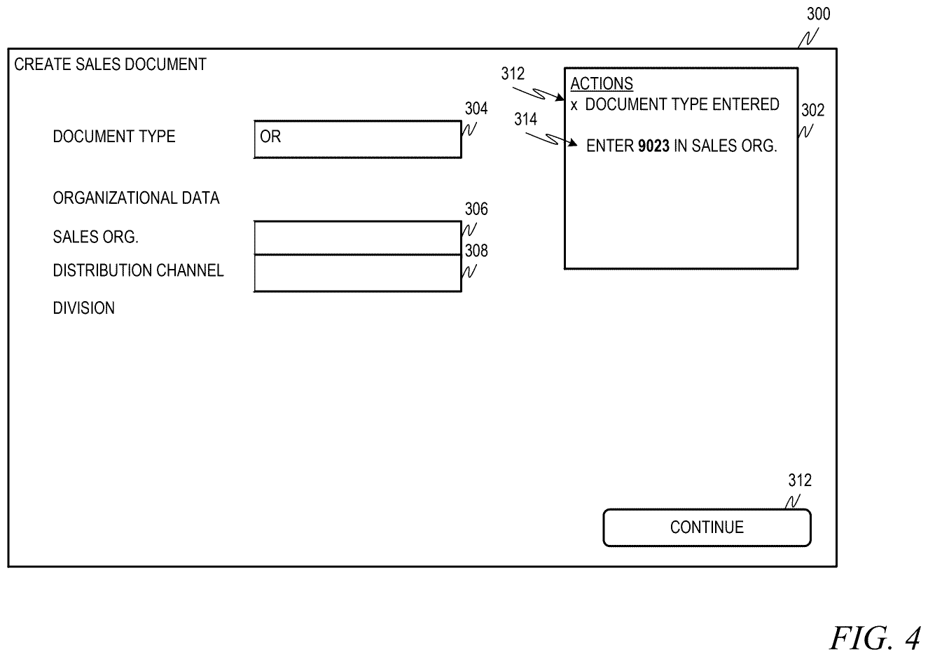

Application map data 132 describes related application actions. For example, the application map data 132 may describe application actions and sequences of application actions that are performed one after another. The application map data 132 may also reference one or more test cases that automate execution of the one or more application actions. The application map data 132 may be generated by the application map analyzer 120 using a trained computerized model, for example, as described herein. An example of application map data is provided in FIG. 4.

Organizational data 134 is data that is maintained by the consumer organization for use by the application 108. Consider the example in which the application 108 is an ERP application for managing human resources. Organizational data 134, in this example, may include data describing employees, employee salaries, employee benefits, and/or the like. Consider another example in which the application 108 is an ERP application for managing operations. The organizational data 134 may include data describing inventories, capacities, and/or the like.

FIG. 1 also shows example software for interfacing the user computing device 102 to the application 108 and training automation tool 104. The user computing device 102 may execute a test automation executor 114. The test automation executor 114 may execute in conjunction with a browser 118. The user 136 may launch an instance of the software application 108 through the browser 118. The user 136 may also launch the training automation tool 104 (and/or components thereof) through the browser 118. For example, the training automation tool 104 may interact with the browser 118, for example, via a browser launcher. The browser launcher may be configured to execute one or more test cases. The test automation executor 114 may be in communication with an automation tool runtime 105 of the training automation tool 104. For example, the automation tool runtime 105 and test automation executor 114 may be configured to provide the user 136 with recommended application actions and/or data by trainer 106 as described herein.

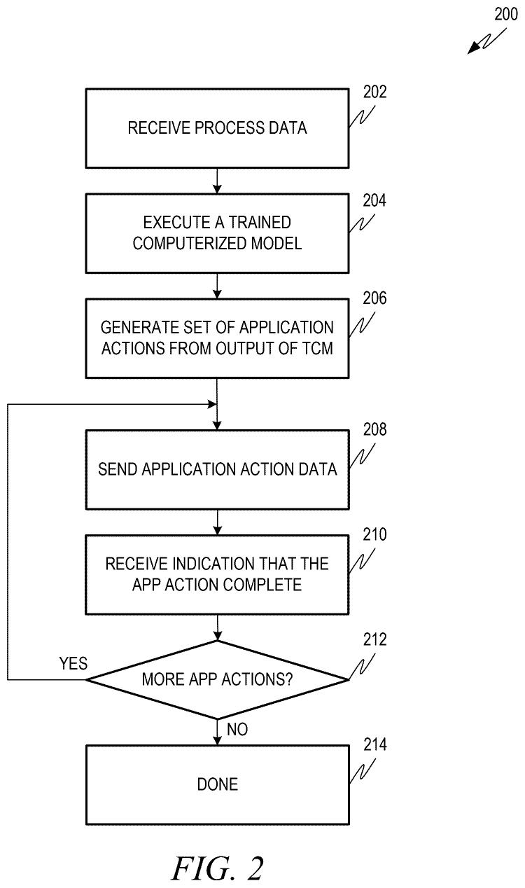

FIG. 2 is a flowchart showing one example of a process flow 200 that may be executed in the environment 100 of FIG. 1 to support the execution of the software application 108. At operation 202, the training automation tool 104 may receive process data. The process data describes an application process that the user 136 would like to perform and/or on which the user 136 would like to be trained. In some examples, the user 136 provides an indication of some or all of the process data through the user computing device 102. The test automation executor 114 may receive the user's input and provide an automation tool runtime 105 of the training automation tool 104.

At operation 204, the training automation tool 104 (e.g., the application map analyzer 120 thereof) may execute the trained computerized model using process data as input. The trained computerized model may be any suitable type of trained computerized model. In some examples, the trained computerized model is or includes a clustering model such as, for example, a K-Means Cluster model or other suitable model. The output of the trained computerized model may include an indication of one or more test cases described by test case data 128. In some examples, the output of the trained computerized model includes an application map stored as application map data 132.

At operation 206, the training automation tool 104 (e.g. the action predicter 126 thereof) may identify a set of application actions that may be performed to implement the application process. In some examples, this includes accessing one or more test cases that are described by the output of the trained computerized model. Also, in some examples, identifying the set of application actions is based on the application map data 132. For example, the training automation tool 104 may identify one or more application actions described by the application map data 132 that are associated with the indicated application process.

At operation 208, the training automation tool 104 generates application action data describing a next application action that is to be implemented by the user 136 in the application 108 to begin or continue execution of the application process. In some examples, this includes selecting data that is to be input by the user 136 as part of the application action. The data selector 122 may be used to select the data from the organizational data 134. In some examples, the data selector 122 generates a data container including data that is to be input by the user 136. The data container may be segregated from organizational data 134. In this way, changes made by the user 136 may not be stored in the organizational data 134. This may facilitate training of the user 136 without attendant risks that the user may change important organizational data. The application action data may be sent to the user computing device 102. In some examples, a user interface screen is provided to the user computing device 102 where the user interface screen indicates the application action data.

At operation 210, the training automation tool 104 receives an indication that the application action described by the application action data has been completed. For example, the training automation tool 104 may be in communication with the application 108 to receive an indication of the completed application action.

At operation 212, the training automation tool 104 determines if there are additional application actions in the set of application actions determined at operation 206. If additional actions remain, the training automation tool 104 may return to operation 208 and generate and send application action data to the user computing device 102 with respect to the next action of the set of application actions. If no more applications remain, the process may conclude at operation 214.

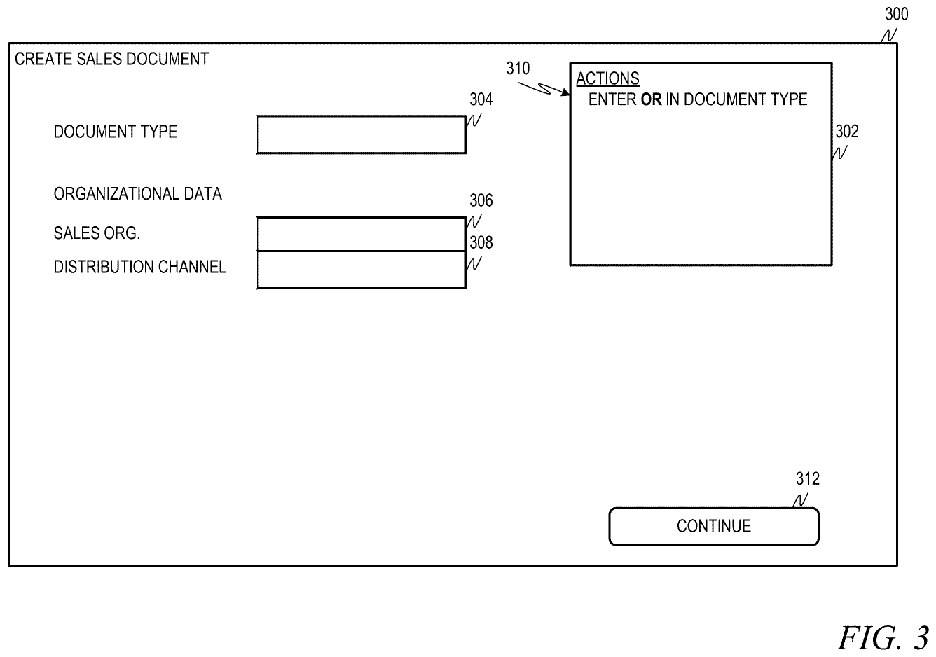

FIG. 3 is a diagram showing one example of a user interface screen 300 that may be served to the user computing device 102 by the application 108 and a user interface screen 302 that may be provided to the user computing device 102 by the training automation tool 104. The user interface screen 300 includes various user interface elements where the user 136 can enter data or select actions to provide data to and/or prompt the application 108.

In the example of FIG. 3, the user interface screen 300 is directed to an example application process for creating a sales document, such as creating a sales order. A Document Type field 304 where the user 136 may enter data describing a type of sales document to be created, a Sales Organization field 306 where the user 136 may enter an indication of a sales organization, and a Distribution Channel field 308 where the user 136 may enter data describing a distribution Channel associated with the sales document.

The user 136, via the user computing device 102, may provide to the training automation tool 104, application process data describing the application process on which the user would like to receive training. In the example of FIG. 3, the application process is a process for creating a sales order. The training automation tool 104 may generate a set of application actions for implementing the application process. The set of application actions may be determined as described herein, for example, with respect to the process flow 200.

The training automation tool 104 may provide the user interface screen 302 including application action data describing the set of application actions. In the example of FIG. 3, the user interface screen 302 includes a training user interface element 310 describing a first application action to be taken by the user. In this example, the first application action is “Enter OR in Document Type.” In this example ‘OR’ is application input data that is to be provided by the user 136 to the application 108 via the Document Type field 304. OR maybe a description of the document type to be generated. Accordingly, the application action data conveyed by the training user interface element 310 includes an action (e.g., enter application action input data), an identity of the application action input data (e.g., OR), and an action input field, such as a field for receiving data and/or a software application control where the user 136 enters data and/or provides control (e.g., Document Type field 304). In this example ‘OR’ indicates that the type of sales document to be created is an order for sales order. In some examples, the training automation tool 104 may automatically suggest the relevant field with the organizational data 134 associated with the application action. For example, the training automation tool 104 may suggest the Document Type field 304 with the value “OR.”

The training automation tool 104 may receive an indication when the user has entered data in the Document Type field 304. In response, the training automation tool 104 may provide additional application action data describing an additional application action from the set of application actions. FIG. 4 shows an example of the user interface screen 300 of FIG. 3. In the example of FIG. 4, the training automation tool 104 is modified to include the training user interface element 310 to indicate that the corresponding application action has been completed. A new training user interface element 314 indicates a next application action. In this example, the next application action is to “Enter 9023 in Sales Org.” The data selector 122 may have selected the value “9023” from organizational data 134, as described herein. The data may be selected, for example, based on data used for the test cases described by test case data 128.

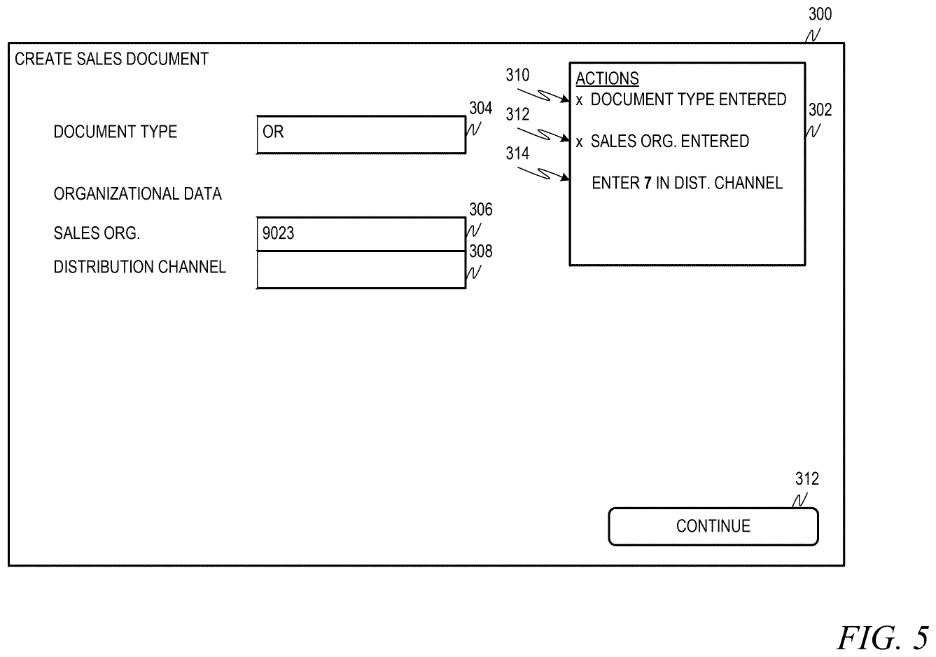

FIG. 5 shows another example of the user interface screen 300 of FIG. 3. In the example of FIG. 5, user 136 has completed another application action by entering “9023” in the sales organization field 306. The training automation tool 104 has updated the training user interface element 312 to indicate completion. The training automation tool 104 has also provided an additional training user interface element 316, providing additional application action data describing the next application action “Enter 7 in Dist. Channel.”

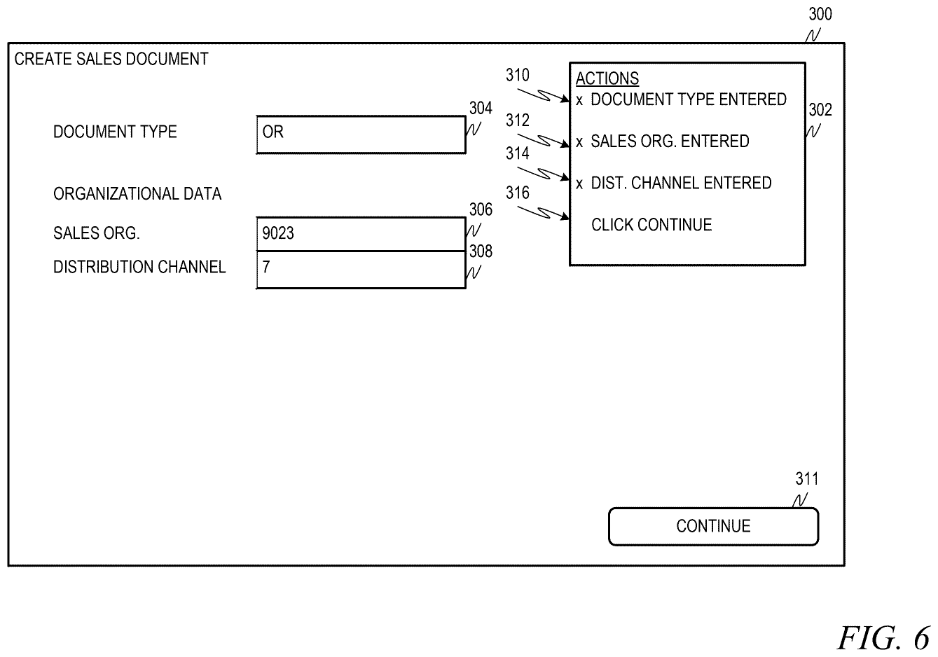

FIG. 6 shows another example of the user interface screen 300 of FIG. 3. In the example of FIG. 6, the user 136 has completed another application action by entering “7” in the Distribution Channel field 308. The training user interface element 314 is modified to indicate completion. Also, the training automation tool 104 has provided an additional training user interface element 316, providing additional application action data describing the next application action, which is “Click Continue.” In response, the user 136 may click the Continue button 311 provided with the user interface screen 300.

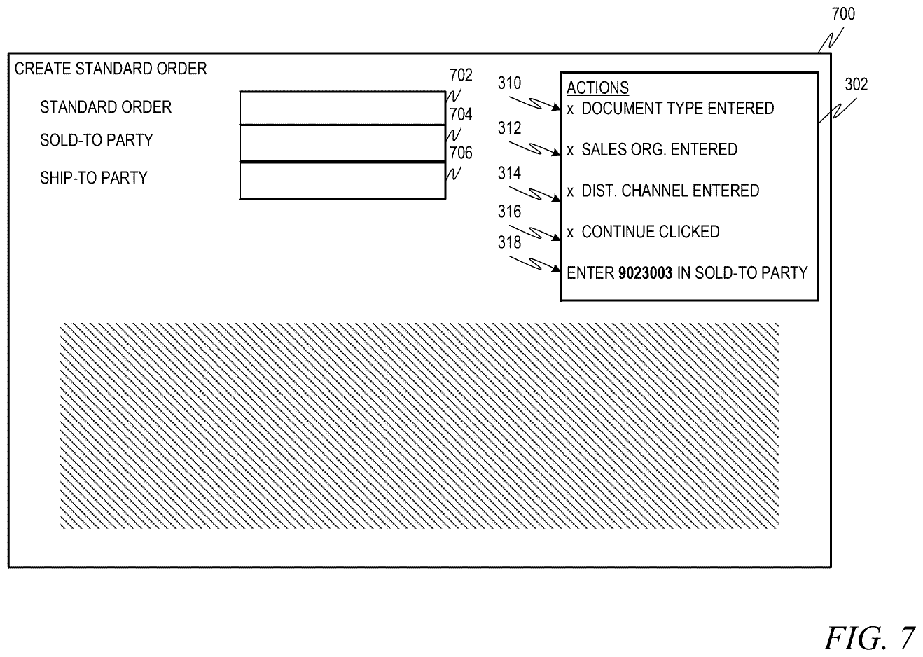

FIG. 7 shows an example of a user interface screen 700 that may be served to the user computing device 102 by the application 108 and the user interface screen 302 that may be provided to the user computing device 102 by the training automation tool 104 in response to selection of the Continue button 311 illustrated by FIG. 6. The user interface screen 700 includes various user interface elements where the user 136 can enter data or select actions to provide data to and/or prompt the application 108. These include a Standard Order field 702, a Sold-to Party field 704, and a Ship-To Party field 706. In the user interface screen 700, the user interface screen 302 is also provided. In the example of FIG. 7, the training user interface element 316 is modified to indicate the completion of the application action by clicking the Continue button 311. The training automation tool 104 has provided an additional training user interface element 318 describing the next application action, which is “Enter 9023003 in Sold-To Party.” The process indicated and described with respect to FIGS. 3-7 may continue, with additional application actions being performed until the application process of creating a sales order is complete.

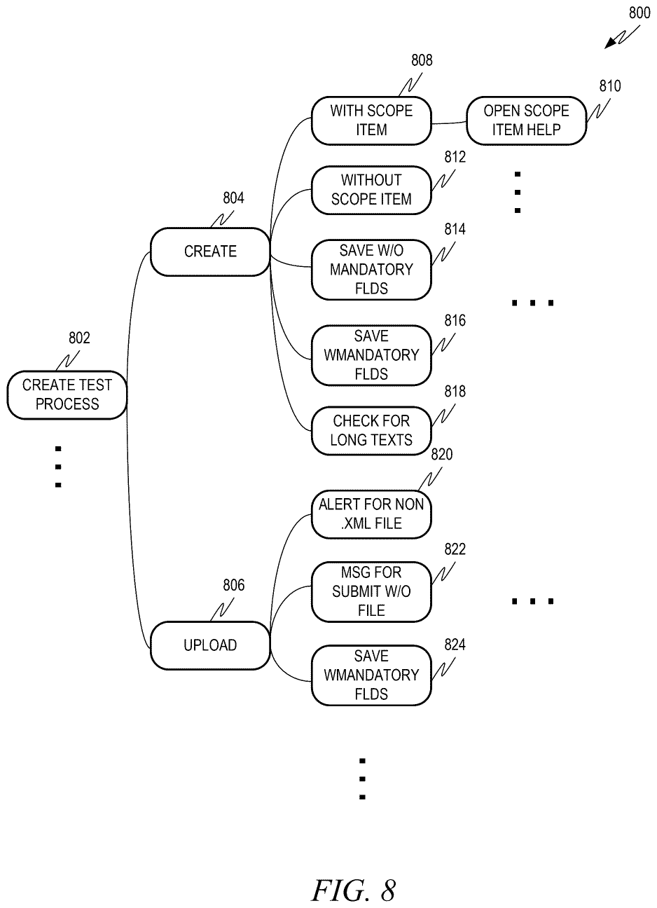

FIG. 8 is a diagram showing an example portion 800 of an application map portion 800 that may be described by the application map data 132. The example portion of the application map portion 800 includes application action elements 802, 804, 806, 808, 810, 812, 814, 816, 818, 820, 822, 824 and relationships therebetween. The application action elements 802, 804, 806, 808, 810, 812, 814, 816, 818, 820, 822, 824 correspond to respective application actions. The example application map portion 800 also describes relationships between the application actions described by the application action elements. For example, lines between application elements 802, 804, 806, 808, 810, 812, 814, 816, 818, 820, 822, 824 indicate sequences of application actions. In some examples, the application map portion 800 may comprise data tying some or all of the application actions to corresponding test cases that involve executing the respective application actions.

For example, the application map portion 800 includes application actions that are related to creating a test process. Following the application map portion 800 from the Create Test Process training user interface element 802 along the lines given to other training user interface elements 804, 806, 808, 810, 812, 814, 816, 818, 820, 822, 824 provides different sequences of application actions that may be performed to bring about the application process of creating a test process.

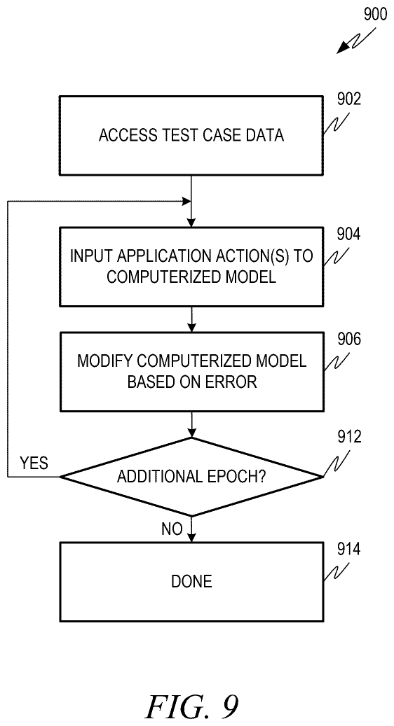

FIG. 9 is a flowchart showing one example of a process flow 900 that may be executed by the training automation tool 104 (e.g., by the application map analyzer 120 thereof) to train the trained computerized model. At operation 902, the training automation tool 104 may access test case data. The test case data may be used as training data. For example, the test case data may describe sequences of application actions that are performed to test the features of the application.

At operation 904, the training automation tool 104 may execute the computerized model with application actions described by the test case data as input. The trained computerized model may generate an output identifying clusters of application actions. The clusters of application actions may be application actions identified by the respective test cases (and/or test cases themselves) that are associated with a common application process. An error may be determined, where the error is a difference between clusters of application actions and/or test cases and known application actions for particular application process. At operation 906, the computerized model may be modified based on the error.

At operation 912, the training automation tool 104 determines if additional training epochs will be performed. If an additional training epoch is to be performed, the training automation tool 104 returns to operation 904 and re-executes the computerized model with the input application actions. If no additional training epochs are to be performed at operation 912, the process may conclude at operation 914.

FIG. 10 is a flowchart showing one example of a process flow 1000 that may be executed in the environment 100 of FIG. 1 to support the execution of the software application 108. In the example of FIG. 10, the training automation tool 104 is arranged to modify its operation in response to the actions of the user 136, for example, by retraining the trained computerized model. For example, the user 136 may perform a suggested application action provided by the training automation tool 104. In some examples, the user 136 may perform a different application action other than the suggested application action. In these examples, the training automation tool 104 may utilize the actual selection of the user 136 to retrain or refine the trained computerized model.

At operation 1002, the training automation tool 104 may receive process data. The process data describes an application process that the user 136 would like to perform and/or on which the user 136 would like to be trained. In some examples, the user 136 provides an indication of some or all of the process data through the user computing device 102. The test automation executor 114 may receive the user's input and provide it to an automation tool runtime 105 of the training automation tool.

At operation 1004, the training automation tool 104 (e.g., the application map analyzer 120 thereof) may execute a trained computerized model using process data as input. In some examples, the output of the trained computerized model includes an application map stored as application map data 132.

At operation 1006, the training automation tool 104 (e.g. the action predicter 126 thereof) may identify a set of application actions that may be performed to implement the application process. In some examples, this includes accessing one or more test cases that are described by the output of the trained computerized model.

At operation 1008, the training automation tool 104 generates application action data describing a next application action that is to be implemented by the user 136 in the application 108 to begin or continue execution of the application process. In some examples, this includes selecting data that is to be input by the user 136 as part of the application action. The data selector 122 may be used to select the data from the organizational data 134. In some examples, the data selector 122 generates a data container including data that is to be input by the user 136 and, for example, data that is to be provided in reply by the application 108.

At operation 1010, the training automation tool 104 receives an indication that the application action described by the application action data has been completed. For example, the training automation tool 104 may be in communication with the browser 118 to receive an indication of the completed application action.

At operation 1012, the training automation tool 104 determines if the application action actually completed by the user 136 is the expected application action. For example, the training automation tool 104 may determine if the application action completed by the user is the same application action that was described by the application action data at operation 1008.

If the actual application action completed by the user 136 is different than the expected application action (e.g., an alternative application action), then the training automation tool 104 may retrain the computerized model at operation 1014. The training automation tool 104 may immediately retrain the computerized model and/or may store a description of the state of the application process including, for example, the application actions actually executed and the application actions from the set of application actions suggested to the user 136. The store data may be used to retrain the computerized model at a later time, for example, in conjunction with other stored data generated in other instances where the user 136 or other users does not perform the suggested/recommended application action. In this way, the accuracy of the trained computerized model may be increased.

If the user 136 performs the expected action at operation 1012, the training automation tool 104 may determine, at operation 1016, if there are additional application actions in the set of application actions determined at operation 1006. If additional actions remain, the training automation tool 104 may return to operation 1008 and generate and send application action data to the user computing device 102 with respect to the next action of the set of application actions. If no more applications remain, the process may conclude at operation 1018.

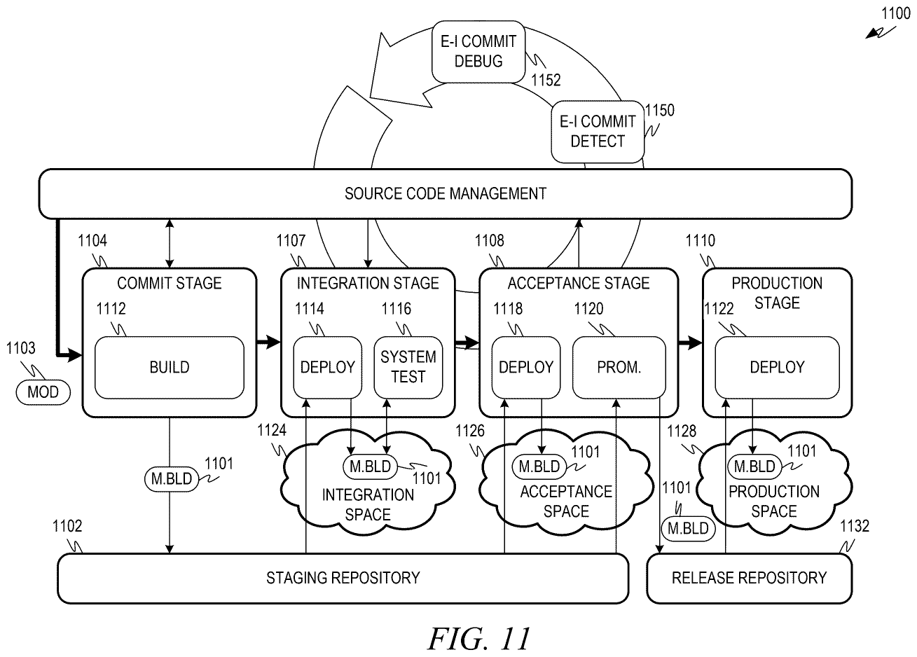

FIG. 11 is a diagram showing one example of a CI/CD pipeline 1100. The CI/CD pipeline 1100, for example, as described herein. In some examples, the test cases used herein may be generated by developers for use in a CI/CD pipeline, such as the CI/CD pipeline 1100. The CI/CD pipeline 1100 is initiated when a developer user submits a build modification 1103 to the commit stage 1104, initiating a commit operation. The build modification 1103 may include a modified version of a mainline build of a software application, previously downloaded by the developer user.

The commit stage 1104 executes a commit operation 1112 to create and/or refine the modified software application build 1101. For example, the mainline may have changed since the time that the developer user downloaded the mainline version used to create the build modification 1103. The modified software application build 1101 generated by commit operation 1112 includes the changes implemented by the modification 1103 as well as any intervening changes to the mainline. The commit operation 1112 and/or commit stage 1104 stores the modified software application build 1101 to a staging repository 1102 where it can be accessed by various other stages of the CI/CD pipeline 1100.

An integration stage 1107 receives the modified software application build 1101 for further testing. A deploy function 1114 of the integration stage 1107 deploys the modified software application build 1101 to an integration space 1124. The integration space 1124 is a test environment to which the modified software application build 1101 can be deployed for testing. While the modified software application build 1101 is deployed at the integration space 1124, a system test function 1116 performs one or more integration tests on the modified software application build 1101. If the modified software application build 1101 fails one or more of the test cases, it may be returned to the developer user for correction. If the modified software application build 1101 passes testing, the integration stage 1107 provides an indication indicating the passed testing to an acceptance stage 1108.

The acceptance stage 1108 uses a deploy function 1118 to deploy the modified software application build 1101 to an acceptance space 1126. The acceptance space 1126 is a test environment to which the modified software application build 1101 can be deployed for testing. While the modified software application build 1101 is deployed at the acceptance space 1126, a promotion function 1120 applies one or more promotion tests to determine whether the modified software application build 1101 is suitable for deployment to a production environment. Example acceptance tests that may be applied by the promotion function 1120 include Newman tests, UiVeri5 tests, Gauge BDD tests, various security tests, etc. If the modified software application build 1101 fails the testing, it may be returned to the developer user for correction. If the modified software application build 1101 passes the testing, the promotion function 1120 may write the modified software application build 1101 to a release repository 1132, from which it may be deployed to production environments.

The example of FIG. 11 shows a single production stage 1110. The production stage 1110 includes a deploy function 1122 that reads the modified software application build 1101 from the release repository 1132 and deploys the modified software application build 1101 to a production space 1128. The production space 1128 may be any suitable production space or environment as described herein.

An error-inducing detection operation 1150 may be executed by the testing system utilizing fault localization, for example, to identify a commit operation that induced an error into the build. The error-inducing commit may be corrected at an error-inducing commit debug operation 1152.

In view of the disclosure above, various examples are set forth below. It should be noted that one or more features of an example, taken in isolation or combination, should be considered within the disclosure of this application.

### EXAMPLES

Example 1 is a system for supporting an application, the system comprising: at least one processor programmed to execute operations comprising: receiving, by a training automation tool and from a user computing device, process data describing an application process to be performed by the user with the application, the training automation tool being executed by the at least one processor; executing, by the training automation tool, a trained computerized model to generate an indication of an application test case for testing at least one feature of the application associated with the application process, the executing of the trained computerized model being based at least in part on the process data; generating, by the training automation tool, a set of application actions for performing the application process, the generating of the set of application actions being based at least in part on the application test case; receiving, by the training automation tool, an indication that the user computing device has completed a first application action of the set of application actions; and sending, by the training automation tool to the user computing device, second application action data describing a second application action of the set of application actions.

In Example 2, the subject matter of Example 1 optionally includes the operations further comprising: receiving, by the application, first application action input data associated with the first application action; serving, by the application and to the user computing device, an application user interface element, the application user interface element comprising a next action input field; and receiving, by the application and from the user computing device, at least a portion of the second application action data at the next action input field.

In Example 3, the subject matter of Example 2 optionally includes the operations further comprising serving, by the training automation tool and to the user computing device, a training user interface element, the training user interface element comprising the second application action data.

In Example 4, the subject matter of any one or more of Examples 2-3 optionally include the sending of the second application action data to the user computing device comprising populating the next action input field with at least a portion of the application second action data.

In Example 5, the subject matter of any one or more of Examples 2-4 optionally include the operations further comprising, responsive to receiving the at least a portion of the second application action data, executing, by the application, the second application action.

In Example 6, the subject matter of any one or more of Examples 1-5 optionally include the operations further comprising: accessing, by the training automation tool, organizational data; generating, by the training automation tool, a training data container, the training data container comprising a portion of the organizational data associated with the application process; and generating, by the training automation tool, at least a portion of the second application action data using the training data container.

In Example 7, the subject matter of any one or more of Examples 1-6 optionally include the second application action data comprising at least one of an indication of a user interface element selectable to initiate the second application action or input data to initiate the second application action.

In Example 8, the subject matter of any one or more of Examples 1-7 optionally include the trained computerized model being arranged to generate application map data, the application map data describing relationships between a plurality of application actions described by the application test case.

In Example 9, the subject matter of Example 8 optionally includes the generating of the set of application actions being based at least in part on the application map data.

In Example 10, the subject matter of any one or more of Examples 1-9 optionally include the trained computerized model being a clustering model.

In Example 11, the subject matter of any one or more of Examples 1-10 optionally include the operations further comprising: accessing test case data describing a plurality of application test cases; and training the trained computerized model using the plurality of application test cases.

In Example 12, the subject matter of any one or more of Examples 1-11 optionally include the operations further comprising: receiving, by the training automation tool, an indication that the user computing device initiated an alternative application action different than the second application action; and using, by the training automation tool, an indication of the alternative application action to modify the trained computerized model.

Example 13 is a method of supporting an application, the method comprising: receiving, by a training automation tool and from a user computing device, process data describing an application process is to be performed by the user with the application, the training automation tool being executed by at least one processor; executing, by the training automation tool, a trained computerized model to generate an indication of an application test case for testing at least one feature of the application associated with the application process, the executing of the trained computerized model being based at least in part on the process data; generating, by the training automation tool, a set of application actions for performing the application process, the generating of the set of application actions being based at least in part on the application test case; receiving, by the training automation tool, an indication that the user computing device has completed a first application action of the set of application actions; and sending, by the training automation tool to the user computing device, second application action data describing a second application action of the set of application actions.

In Example 14, the subject matter of Example 13 optionally includes receiving, by the application, first application action input data associated with the first application action; serving, by the application and to the user computing device, an application user interface element, the application user interface element comprising a next action input field; and receiving, by the application and from the user computing device, at least a portion of the second application action data at the next action input field.

In Example 15, the subject matter of Example 14 optionally includes serving, by the training automation tool and to the user computing device, a training user interface element, the training user interface element comprising the second application action data.

In Example 16, the subject matter of any one or more of Examples 14-15 optionally include the sending of the second application action data to the user computing device comprising populating the next action input field with at least a portion of the application second action data.

In Example 17, the subject matter of any one or more of Examples 14-16 optionally include responsive to receiving the at least a portion of the second application action data, executing, by the application, the second application action.

In Example 18, the subject matter of any one or more of Examples 13-17 optionally include accessing, by the training automation tool, organizational data; generating, by the training automation tool, a training data container, the training data container comprising a portion of the organizational data associated with the application process; and generating, by the training automation tool, at least a portion of the second application action data using the training data container.

In Example 19, the subject matter of any one or more of Examples 13-18 optionally include the second application action data comprising at least one of an indication of a user interface element selectable to initiate the second application action or input data to initiate the second application action.

Example 20 is a non-transitory machine-readable medium comprising instructions thereon that, when executed by at least one processor, because at least one processor to execute operations comprising: receiving, by a training automation tool and from a user computing device, process data describing an application process is to be performed by the user with the application, the training automation tool being executed by at least one processor; executing, by the training automation tool, a trained computerized model to generate an indication of an application test case for testing at least one feature of the application associated with the application process, the executing of the trained computerized model being based at least in part on the process data; generating, by the training automation tool, a set of application actions for performing the application process, the generating of the set of application actions being based at least in part on the application test case; receiving, by the training automation tool, an indication that the user computing device has completed a first application action of the set of application actions; and sending, by the training automation tool to the user computing device, second application action data describing a second application action of the set of application actions.

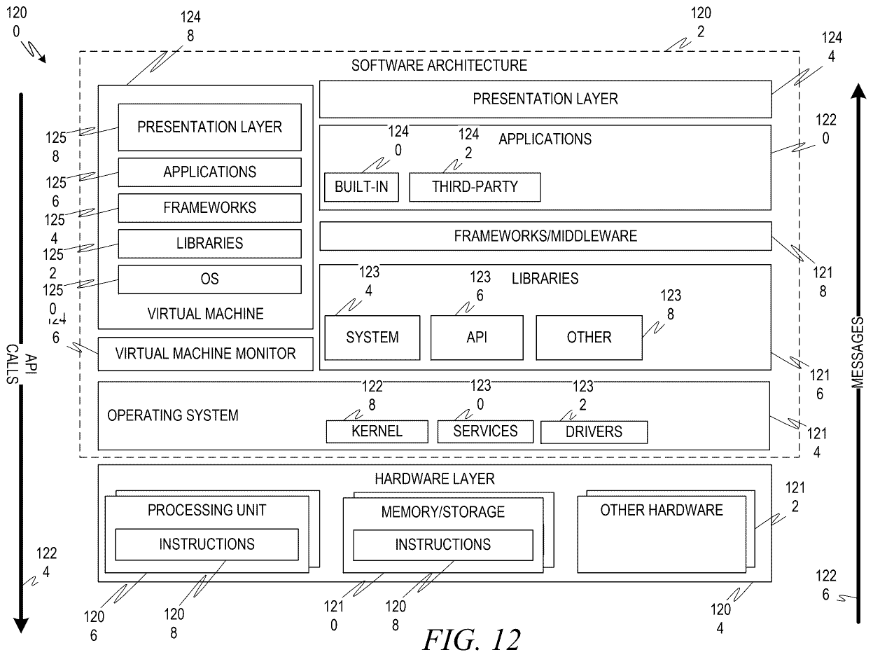

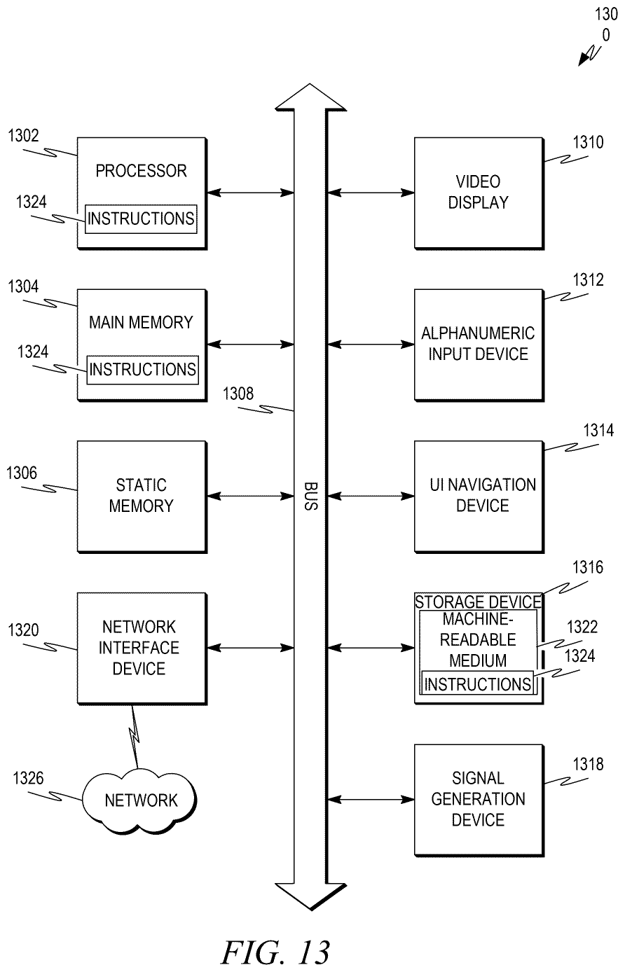

FIG. 12 is a block diagram 1200 showing one example of a software architecture 1202 for a computing device. The software architecture 1202 may be used in conjunction with various hardware architectures, for example, as described herein. FIG. 12 is merely a non-limiting example of a software architecture and many other architectures may be implemented to facilitate the functionality described herein. The software architecture 1202 and various other components described in FIG. 12 may be used to implement various other systems described herein. For example, the software architecture 1202 shows one example way for implementing the user computing device 102 and/or various computing architectures for the training automation tool 104, application 108, and DBMS 110. In FIG. 12, a representative hardware layer 1204 is illustrated and can represent, for example, any of the above-referenced computing devices. In some examples, the hardware layer 1204 may be implemented according to the architecture of the computer system of FIG. 13.

The representative hardware layer 1204 comprises one or more processing units 1206 having associated executable instructions 1208. Executable instructions 1208 represent the executable instructions of the software architecture 1202, including implementation of the methods, modules, systems, and components, and so forth described herein and may also include memory and/or storage modules 1210, which also have executable instructions 1208. Hardware layer 1204 may also comprise other hardware as indicated by other hardware 1212 which represents any other hardware of the hardware layer 1204, such as the other hardware illustrated as part of the software architecture 1202.

In the example architecture of FIG. 12, the software architecture 1202 may be conceptualized as a stack of layers where each layer provides particular functionality. For example, the software architecture 1202 may include layers such as an operating system 1214, libraries 1216, middleware layer 1218 (sometimes referred to as frameworks), applications 1220, and presentation layer 1244. Operationally, the applications 1220 and/or other components within the layers may invoke API calls 1224 through the software stack and access a response, returned values, and so forth illustrated as messages 1226 in response to the API calls 1224. The layers illustrated are representative in nature and not all software architectures have all layers. For example, some mobile or special purpose operating systems may not provide the middleware layer 1218, while others may provide such a layer. Other software architectures may include additional or different layers.

The operating system 1214 may manage hardware resources and provide common services. The operating system 1214 may include, for example, a kernel 1228, services 1230, and drivers 1232. The kernel 1228 may act as an abstraction layer between the hardware and the other software layers. For example, the kernel 1228 may be responsible for memory management, processor management (e.g., scheduling), component management, networking, security settings, and so on. The services 1230 may provide other common services for the other software layers. In some examples, the services 1230 include an interrupt service. The interrupt service may detect the receipt of an interrupt and, in response, cause the software architecture 1202 to pause its current processing and execute an interrupt service routine (ISR) when an interrupt is accessed.

The drivers 1232 may be responsible for controlling or interfacing with the underlying hardware. For instance, the drivers 1232 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1216 may provide a common infrastructure that may be utilized by the applications 1220 and/or other components and/or layers. The libraries 1216 typically provide functionality that allows other software modules to perform tasks in an easier fashion than to interface directly with the underlying operating system 1214 functionality (e.g., kernel 1228, services 1230 and/or drivers 1232). The libraries 1216 may include system 1234 libraries (e.g., C standard library) that may provide functions such as memory allocation functions, string manipulation functions, mathematic functions, and/or the like. In addition, the libraries 1216 may include API libraries 1236 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and/or the like. The libraries 1216 may also include a wide variety of other libraries 1238 to provide many other APIs to the applications 1220 and other software components/modules.

The middleware layer 1218 (also sometimes referred to as frameworks) may provide a higher-level common infrastructure that may be utilized by the applications 1220 and/or other software components/modules. For example, the middleware layer 1218 may provide various graphic user interface (GUI) functions, high-level resource management, high-level location services, and so forth. The middleware layer 1218 may provide a broad spectrum of other APIs that may be utilized by the applications 1220 and/or other software components/modules, some of which may be specific to a particular operating system or platform.

The applications 1220 include built-in applications 1240 and/or third-party applications 1242. Examples of representative built-in applications 1240 may include, but are not limited to, a contacts application, a browser application, a book reader application, a location application, a media application, a messaging application, and/or a game application. Third-party applications 1242 may include any of the built-in applications 1240 as well as a broad assortment of other applications. In a specific example, the third-party application 1242 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1242 may invoke the API calls 1224 provided by the mobile operating system, such as operating system 1214, to facilitate functionality described herein.

The applications 1220 may utilize built-in operating system functions (e.g., kernel 1228, services 1230 and/or drivers 1232), libraries (e.g., system 1234, API libraries 1236, and other libraries 1238), and middleware layer 1218 to create user interfaces to interact with users of the system. Alternatively, or additionally, in some systems interactions with a user may occur through a presentation layer, such as presentation layer 1244. In these systems, the application/module “logic” can be separated from the aspects of the application/module that interact with a user.

Some software architectures utilize virtual machines. For example, the various environments described herein may implement one or more virtual machines executing to provide a software application or service. The example of FIG. 12 illustrates by virtual machine 1248. A virtual machine creates a software environment where applications/modules can execute as if they were executing on a hardware computing device. A virtual machine 1248 is hosted by a host operating system (operating system 1214) and typically, although not always, has a virtual machine monitor 1246, which manages the operation of the virtual machine 1248 as well as the interface with the host operating system (i.e., operating system 1214). A software architecture executes within the virtual machine 1248. The software architecture may be or include, for example, an operating system 1250, libraries 1252, frameworks/middleware 1254, applications 1256 and/or presentation layer 1258. These layers of software architecture executing within the virtual machine 1248 can be the same as corresponding layers previously described or may be different.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

Computer software, including code for implementing software services, can be written in any form of programming language, including compiled or interpreted languages, and it can be deployed in any form, including as a standalone program or as a module, subroutine, or other unit suitable for use in a computing environment. Computer software can be deployed to be executed on one computer or on multiple computers at one site or distributed across multiple sites and interconnected by a communication network.

In example embodiments, operations may be performed by one or more programmable processors executing a computer program to perform functions by operating on input data and generating output.

FIG. 13 is a block diagram of a machine in the example form of a computer system 1300 within which instructions 1324 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU), or both), a main memory 1304, and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard or a touch-sensitive display screen), a user interface (UI) navigation (or cursor control) device 1314 (e.g., a mouse), a storage device 1316, such as a disk drive unit, a signal generation device 1318 (e.g., a speaker), and a network interface device 1320.

The storage device 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304 and/or within the processor 1302 during execution thereof by the computer system 1300, with the main memory 1304 and the processor 1302 also constituting machine-readable media 1322.

While the machine-readable medium 1322 is shown in an example embodiment to be a single medium, the term “machine-readable medium” may include a single medium or multiple media (e.g., a centralized or distributed database, and/or associated caches and servers) that store the one or more instructions 1324 or data structures. The term “machine-readable medium” shall also be taken to include any tangible medium that is capable of storing, encoding, or carrying instructions 1324 for execution by the machine and that cause the machine to perform any one or more of the methodologies of the present disclosure, or that is capable of storing, encoding, or carrying data structures utilized by or associated with such instructions 1324. The term “machine-readable medium” shall accordingly be taken to include, but not be limited to, solid-state memories, and optical and magnetic media. Specific examples of machine-readable media 1322 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 1324 may further be transmitted or received over a communications network 1326 using a transmission medium. The instructions 1324 may be transmitted using the network interface device 1320 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 1324 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system for supporting an application, the system comprising:
at least one processor programmed to execute operations comprising:
receiving, by a training automation tool and from a user computing device, process data describing an application process to be performed by the user with the application, the training automation tool being executed by the at least one processor;
executing, by the training automation tool, a trained computerized model to generate an indication of an application test case for testing at least one feature of the application associated with the application process, the executing of the trained computerized model being based at least in part on the process data;
generating, by the training automation tool, a set of application actions for performing the application process, the generating of the set of application actions being based at least in part on the application test case;
receiving, by the training automation tool, an indication that the user computing device has completed a first application action of the set of application actions; and
sending, by the training automation tool to the user computing device, second application action data describing a second application action of the set of application actions.

2. The system of claim 1, the operations further comprising:
receiving, by the application, first application action input data associated with the first application action;
serving, by the application and to the user computing device, an application user interface element, the application user interface element comprising a next action input field; and
receiving, by the application and from the user computing device, at least a portion of the second application action data at the next action input field.

3. The system of claim 2, the operations further comprising serving, by the training automation tool and to the user computing device, a training user interface element, the training user interface element comprising the second application action data.

4. The system of claim 2, the sending of the second application action data to the user computing device comprising populating the next action input field with at least a portion of the application second action data.

5. The system of claim 2, the operations further comprising, responsive to receiving the at least a portion of the second application action data, executing, by the application, the second application action.

6. The system of claim 1, the operations further comprising:
accessing, by the training automation tool, organizational data;
generating, by the training automation tool, a training data container, the training data container comprising a portion of the organizational data associated with the application process; and
generating, by the training automation tool, at least a portion of the second application action data using the training data container.

7. The system of claim 1, the second application action data comprising at least one of an indication of a user interface element selectable to initiate the second application action or input data to initiate the second application action.

8. The system of claim 1, the trained computerized model being arranged to generate application map data, the application map data describing relationships between a plurality of application actions described by the application test case.

9. The system of claim 8, the generating of the set of application actions being based at least in part on the application map data.

10. The system of claim 1, the trained computerized model being a clustering model.

11. The system of claim 1, the operations further comprising:
accessing test case data describing a plurality of application test cases; and
training the trained computerized model using the plurality of application test cases.

12. The system of claim 1, the operations further comprising:
receiving, by the training automation tool, an indication that the user computing device initiated an alternative application action different than the second application action; and
using, by the training automation tool, an indication of the alternative application action to modify the trained computerized model.

13. A method of supporting an application, the method comprising:
receiving, by a training automation tool and from a user computing device, process data describing an application process is to be performed by the user with the application, the training automation tool being executed by at least one processor;
executing, by the training automation tool, a trained computerized model to generate an indication of an application test case for testing at least one feature of the application associated with the application process, the executing of the trained computerized model being based at least in part on the process data;
generating, by the training automation tool, a set of application actions for performing the application process, the generating of the set of application actions being based at least in part on the application test case;
receiving, by the training automation tool, an indication that the user computing device has completed a first application action of the set of application actions; and
sending, by the training automation tool to the user computing device, second application action data describing a second application action of the set of application actions.

14. The method of claim 13, further comprising:
receiving, by the application, first application action input data associated with the first application action;
serving, by the application and to the user computing device, an application user interface element, the application user interface element comprising a next action input field; and
receiving, by the application and from the user computing device, at least a portion of the second application action data at the next action input field.

15. The method of claim 14, further comprising serving, by the training automation tool and to the user computing device, a training user interface element, the training user interface element comprising the second application action data.

16. The method of claim 14, the sending of the second application action data to the user computing device comprising populating the next action input field with at least a portion of the application second action data.

17. The method of claim 14, further comprising, responsive to receiving the at least a portion of the second application action data, executing, by the application, the second application action.

18. The method of claim 13, further comprising:
accessing, by the training automation tool, organizational data;
generating, by the training automation tool, a training data container, the training data container comprising a portion of the organizational data associated with the application process; and
generating, by the training automation tool, at least a portion of the second application action data using the training data container.

19. The method of claim 13, the second application action data comprising at least one of an indication of a user interface element selectable to initiate the second application action or input data to initiate the second application action.

20. A non-transitory machine-readable medium comprising instructions thereon that, when executed by at least one processor, because at least one processor to execute operations comprising:
receiving, by a training automation tool and from a user computing device, process data describing an application process is to be performed by the user with the application, the training automation tool being executed by at least one processor;
executing, by the training automation tool, a trained computerized model to generate an indication of an application test case for testing at least one feature of the application associated with the application process, the executing of the trained computerized model being based at least in part on the process data;
generating, by the training automation tool, a set of application actions for performing the application process, the generating of the set of application actions being based at least in part on the application test case;
receiving, by the training automation tool, an indication that the user computing device has completed a first application action of the set of application actions; and
sending, by the training automation tool to the user computing device, second application action data describing a second application action of the set of application actions.
